(19) United States
(12) Patent Application Publication
(10) Pub. No.: US 2026/0301634 A1
(43) Pub. Date: Oct. 1, 2026

(54) DISPLAY DEVICE AND ELECTRONIC DEVICE

(71) Applicant: Samsung Display Co., Ltd., Yongin-Si (KR)

(72) Inventors: Jong Deuk MOON, Yongin-si (KR); Seung Woon SHIN, Yongin-si (KR); Kyoung Soo KIM, Yongin-si (KR); Ho LEE, Yongin-si (KR); Woon Rok JANG, Yongin-si (KR)

(21) Appl. No.: 19/386,787

(22) Filed: Nov. 12, 2025

(30) Foreign Application Priority Data
Apr. 1, 2025 (KR) 10-2025-0041870

(51) Int. Cl. G09G 3/20; G09G 3/3233

(52) U.S. Cl. CPC G09G 3/2007; G09G 3/3233; G09G 2300/0842; G09G 2310/08; G09G 2320/0233; G09G 2320/029; G09G 2340/16; G09G 2360/16

(57) ABSTRACT

A display device of the present disclosure including a grayscale compensation unit generating compensation grayscales of a second frame by compensating second grayscales of a second frame using first grayscales of a first frame image and the second grayscales of a second frame image; and pixels displaying the second frame image based on the compensation grayscales, wherein the grayscale compensation unit detects a high luminance pattern in the first frame image and generates the compensation grayscales if, based on the second grayscales, a copy pattern of the high luminance pattern is predicted to be displayed in the second frame image.

### BACKGROUND

This application claims priority to Korean Patent Application No. 10-2025-0041870, filed on Apr. 1, 2025, and all the benefits accruing therefrom under 35 U.S.C. § 119, the content of which in its entirety is herein incorporated by reference.

### 1. Technical Field

The present disclosure relates to a display device and an electronic device.

### 2. Description of the Related Art

With the development of information technology, the importance of display devices as a medium of connection between users and information has become increasingly important. In response to this, the use of display devices such as liquid crystal display devices and organic light emitting display devices is increasing.

The display device may display images at different frequencies depending on the user's needs. In doing so, various side effects such as luminance changes, flicker, and speckling may occur.

### SUMMARY

The technical challenge to be addressed is to provide display devices and electronic devices that can effectively eliminate or mitigate copy patterns.

A display device according to one embodiment of the present disclosure, including: a grayscale compensation unit generating compensation grayscales of a second frame by compensating second grayscales of the second frame using first grayscales of a first frame image and the second grayscales of a second frame image; and pixels displaying the second frame image based on the compensation grayscales, wherein the grayscale compensation unit detects a high luminance pattern in the first frame image and generates the compensation grayscales if, based on the second grayscales, a copy pattern of the high luminance pattern is predicted to be displayed in the second frame image.

The grayscale compensation unit may further include: a high luminance pattern detection unit providing position information of first pixels displaying the high luminance pattern.

The grayscale compensation unit may further include: a compensation area determination unit determining, based on frequency information, an overlap period of a last self-scan period of a first frame period and an address scan period of a second frame period, and providing position information of second pixels receiving data voltages of the second frame image during the overlap period.

The grayscale compensation unit may further include: a copy pattern prediction unit providing, based on position information of the first pixels and position information of the second pixels, positions of the second pixels receiving data voltages of the second frame image at luminance initialization times of the first pixels, as copy pattern position information.

The grayscale compensation unit may further include: an output grayscale determination unit generating compensation values based on the second grayscales of the second pixels and the first grayscales of the first pixels corresponding to the copy pattern position information, and applying the compensation values to the second grayscales to generate the compensation grayscales.

The grayscale compensation unit may include: a high luminance pattern detection unit providing a histogram of the first grayscales and first position information of first pixels corresponding to the high luminance pattern; and a histogram analysis unit providing second position information of the first pixels corresponding to the high luminance pattern if, based on the histogram, a grayscale difference between the high luminance pattern and low luminance pattern is greater than a first threshold value.

The grayscale compensation unit may further include: a compensation area determination unit determining, based on frequency information, an overlap period of a last self-scan period of a first frame period and an address scan period of a second frame period, and providing position information of second pixels receiving data voltages of the second frame image during the overlap period.

The grayscale compensation unit may further include: a copy pattern prediction unit providing, based on position information of the first pixels and position information of the second pixels, positions of the second pixels receiving data voltages of the second frame image at luminance initialization times of the first pixels as first copy pattern position information.

The grayscale compensation unit may further include: a grayscale difference comparison unit providing a second copy pattern position information corresponding to the first copy pattern position information if a difference between the second grayscales of the second pixels and the first grayscales of the first pixels corresponding to the first copy pattern position information is greater than a second threshold value.

The grayscale compensation unit may further include: an output grayscale determination unit generating compensation values based on the second grayscales of the second pixels and the first grayscales of the first pixels corresponding to the second copy pattern position information, and applying the compensation values to the second grayscales to generate the compensation grayscales.

An electronic device according to one embodiment of the present disclosure, including: a processor providing an image signal; and a display device displaying an image based on the image signal, wherein the display device includes: a grayscale compensation unit generating compensation grayscales of a second frame by compensating second grayscales of the second frame using first grayscales of a first frame image and the second grayscales of a second frame image; and pixels displaying the second frame image based on the compensation grayscales, wherein the grayscale compensation unit detects a high luminance pattern in the first frame image, and generates the compensation grayscales if, based on the second grayscales, a copy pattern of the high luminance pattern is predicted to be displayed in the second frame image.

The grayscale compensation unit may include: a high luminance pattern detection unit providing position information of first pixels displaying the high luminance pattern.

The grayscale compensation unit may further include: a compensation area determination unit determining, based on frequency information, an overlap period of a last self-scan period of a first frame period and an address scan period of a second frame period, and providing position information of second pixels receiving data voltages of the second frame image during the overlap period.

The grayscale compensation unit may further include: a copy pattern prediction unit providing, based on position information of the first pixels and position information of the second pixels, positions of the second pixels receiving data voltages of the second frame image at luminance initialization times of the first pixels as copy pattern position information.

The grayscale compensation unit may further include: an output grayscale determination unit generating compensation values based on the second grayscales of the second pixels and the first grayscales of the first pixels corresponding to the copy pattern position information, and applying the compensation values to the second grayscales to generate the compensation grayscales.

The grayscale compensation unit may include: a high luminance pattern detection unit providing a histogram of the first grayscales and first position information of first pixels corresponding to the high luminance pattern; and a histogram analysis unit providing second position information of the first pixels corresponding to the high luminance pattern if, based on the histogram, a grayscale difference between the high luminance pattern and low luminance pattern is greater than a first threshold value.

The grayscale compensation unit may further include: a compensation area determination unit detecting, based on frequency information, an overlap period of a last self-scan period of a first frame period and an address scan period of a second frame period, and providing position information of second pixels receiving data voltages of the second frame image during the overlap period.

The grayscale compensation unit may further include: a copy pattern prediction unit providing, based on position information of the first pixels and position information of the second pixels, positions of the second pixels receiving data voltages of the second frame image at luminance initialization times of the first pixels as first copy pattern position information.

The grayscale compensation unit may further include: a grayscale difference comparison unit providing a second copy pattern position information corresponding to the first copy pattern position information if a difference between the second grayscales of the second pixels and the first grayscales of the first pixels corresponding to the first copy pattern position information is greater than a second threshold value.

The grayscale compensation unit may further include: an output grayscale determination unit generating compensation values based on the second grayscales of the second pixels and the first grayscales of the first pixels corresponding to the second copy pattern position information, and applying the compensation values to the second grayscales to generate the compensation grayscales.

### BRIEF DESCRIPTION OF THE DRAWINGS

The above and other features of the disclosure will become more apparent by describing in further detail embodiments thereof with reference to the accompanying drawings, in which:

FIG. 1 is a drawing to illustrate a display device according to one embodiment of the present invention.

FIG. 2 is a drawing to illustrate a pixel and a sensing channel according to one embodiment of the present disclosure.

FIG. 3 is a drawing to illustrate an address scan period according to one embodiment of the present disclosure.

FIG. 4 is a drawing to illustrate a threshold voltage sensing period of a transistor according to one embodiment of the present disclosure.

FIG. 5 is a drawing for illustrating a mobility sensing period according to one embodiment of the present disclosure.

FIG. 6 is a diagram to illustrate the difference in luminance as frequency changes.

FIG. 7 is a drawing to illustrate a self-scan period according to one embodiment of the present disclosure.

FIG. 8 is a drawing to illustrate the relaxation of luminance differences as frequency changes.

FIG. 9 is a diagram to illustrate a case where no copy pattern appears.

FIG. 10 is a diagram to illustrate when a copy pattern appears.

FIG. 11 is a drawing to illustrate a grayscale compensation unit according to one embodiment of the present disclosure.

FIG. 12 is a drawing to illustrate a grayscale compensation unit according to another embodiment of the present disclosure.

FIG. 13 is a drawing to illustrate a histogram analysis unit according to one embodiment of the present disclosure.

FIG. 14 is a drawing to illustrate an output grayscale determination unit according to one embodiment of the present disclosure.

FIG. 15 is a block diagram of an electronic device according to one embodiment.

FIGS. 16, 17 and FIG. 18 are schematic diagrams of electronic devices according to various embodiments.

### DETAILED DESCRIPTION OF THE EMBODIMENT

Hereinafter, with reference to the accompanying drawings, various embodiments of the present disclosure will be described in detail to facilitate practice by one having ordinary skill in the art to which the disclosure belongs. The disclosure may be implemented in many different forms and is not limited to the embodiments described herein.

In order to clearly illustrate the present disclosure, portions not pertinent to the description have been omitted, and identical or similar components have been designated by the same reference numerals throughout the specification. Accordingly, the aforementioned reference numerals may be used in other drawings.

Further, the size and thickness of each configuration shown in the drawings is arbitrarily indicated for ease of illustration and the disclosure is not necessarily limited to that shown. Thicknesses may be exaggerated in the drawings to clearly represent the various layers and regions.

Also, when “identical” is used in the description, it may mean “substantially identical,” i.e., identical to the extent that a person of ordinary skill would be led to believe that they are identical. Other expressions may also omit “substantially”.

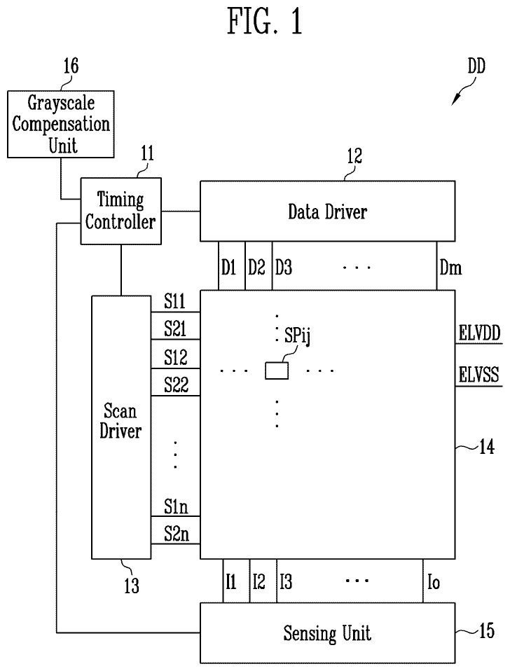

FIG. 1 is a drawing to illustrate a display device according to one embodiment of the present disclosure.

Referring to FIG. 1, a display device DD according to one embodiment of the present disclosure may include a timing controller 11, a data driver 12, a scan driver 13, a pixel unit 14, a sensing unit 15, and a grayscale compensation unit 16.

The timing controller 11 may receive an image signal from a processor. The image signal may include grayscales for each frame (e.g., an image frame). Further, the timing controller 11 may receive control signals from the processor. The processor may correspond to at least one of a graphics processing unit (GPU), a central processing unit (CPU), an application processor (AP), and the like.

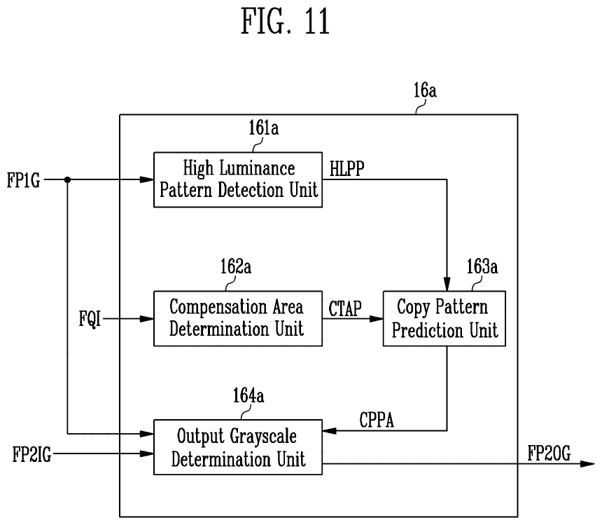

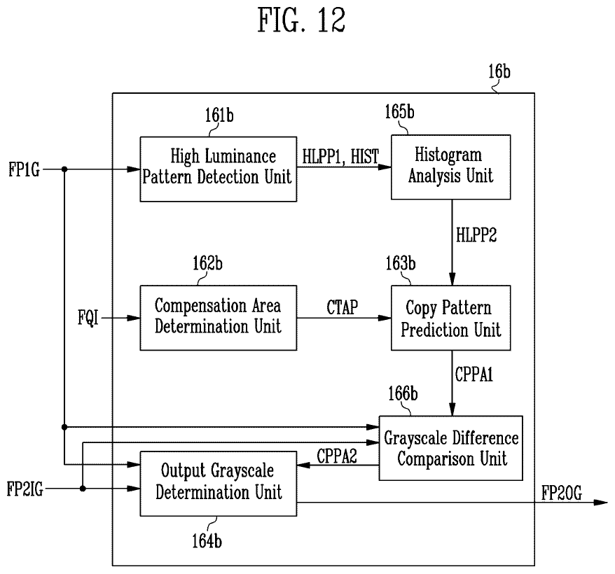

The grayscale compensation unit 16 may receive the grayscales from the timing controller 11 and provide compensation grayscales by compensating the grayscales. For example, the gray scale compensation unit 16 may generate the compensation grayscales by compensating the second grayscales using the first grayscales of the first frame image and the second grayscales of the second frame image. The second frame image may correspond to a subsequence frame of the first frame image. The detailed configuration and operation of the grayscale compensation unit 16 will be described later with reference to FIGS. 11 and 12.

The timing controller 11 may generate the output grayscales in a variety of ways. For example, the timing controller 11 may generate the output grayscales identical to the grayscales received from the processor. In addition, the timing controller 11 may provide compensation grayscales provided by the grayscale compensation unit 16 as the output grayscales. Further, the timing controller 11 may generate the output grayscales by applying sensing data provided by the sensing unit 15 to the grayscales or the compensation grayscales.

The timing controller 11 may provide the output grayscales to the data driver 12. Further, the timing controller 11 may provide control signals suitable for their respective specifications to the data driver 12, the scan driver 13, the sensing unit 15, and the grayscale compensation unit 16.

In a display period, the data driver 12 may generate data voltages to be provided to the data lines D1, D2, D3, . . . , Dm by utilizing the output grayscales and control signals received from the timing controller 11. For example, the data driver 12 may sample the output grayscales using a clock signal and convert the sampled output grayscales into data voltages. The data driver 12 may apply the data voltages to the data lines D1 through Dm in a unit of a pixel row, here “m” may be an integer greater than zero. Here, the pixel row means pixels connected to the same scan lines. In a sensing period, the data driver 12 may supply a reference voltage to the data lines D1 to Dm.

The scan driver 13 may receive clock signals, scan start signal, and the like from the timing controller 11 to generate first scan signals to be provided to the first scan lines S11, S12, . . . , S1n and second scan signals to be provided to the second scan lines S21, S22, . . . , S2n, where “n” may be an integer greater than zero.

For example, the scan driver 13 may sequentially supply first scan signals having pulses of a turn-on level to the first scan lines S11 through S1n. Further, the scan driver 13 may sequentially supply the second scan signals having pulses of the turn-on level to the second scan lines S21 to S2n. For example, the scan driver 13 may include a first scan driver connected to the first scan lines S11, S12, . . . , S1n and a second scan driver connected to the second scan lines S21, S22, . . . , S2n. Each of the first scan driver and the second scan driver may include scan stages organized in the form of a shift register. Each of the first scan driver and the second scan driver may generate scan signals by sequentially delivering a scan start signal in the form of a pulse at a turn-on level to the next scan stage under control of a clock signal.

In the display period, the sensing unit 15 may supply an initialization voltage to the sensing lines I1, I2, I3, . . . , Io, where “o” may be an integer greater than zero. In the sensing period, the sensing unit 15 may receive sensing voltages from the sensing lines I1 to Io connected to the pixels.

The sensing unit 15 may include sensing channels connected to the sensing lines I1 through Io. For example, the sensing lines I1 to Io and the sensing channels may have one-to-one correspondence. For example, the number of sensing lines I1 to Io and the number of sensing channels may be the same. In other embodiments, the number of sensing channels may be less than the number of sensing lines I1 to Io. In this case, the sensing unit 15 may further include demultiplexers to perform time-division sensing of the pixels.

The pixel unit 14 includes pixels. Each pixel may include a pixel emitting light of a first color, a pixel emitting light of a second color, and a pixel emitting light of a third color. The first color, the second color, and the third color may be different colors.

Each pixel SPij can be connected to a corresponding data line, scan line, and sensing line. The pixels may be connected to a first power supply line ELVDD and a second power supply line ELVSS. For example, during the display period, the voltage of the first power supply line ELVDD may be greater than the voltage of the second power supply line ELVSS.

Depending on the embodiment, at least two of the timing controller 11, the data driver 12, the scan driver 13, the pixel unit 14, the sensing unit 15, and the grayscale compensation unit 16 may be configured as any integrated chip (IC). Configurations of each of the functional units shown in FIG. 1, either separately or in combination, are within the scope of those skilled in the art to make modifications, and therefore the number of such modifications is omitted.

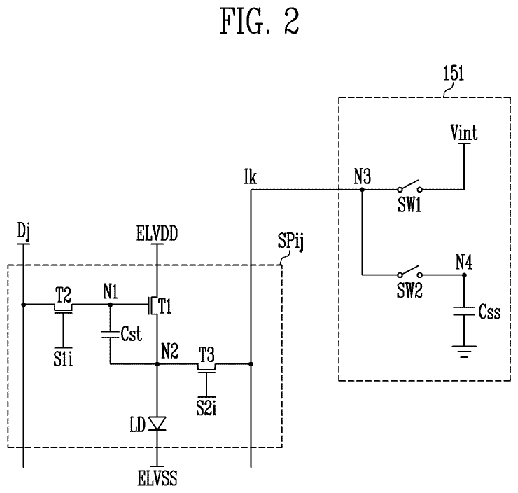

FIG. 2 is a drawing to illustrate a pixel and a sensing channel according to one embodiment of the present disclosure.

The pixel SPij may include transistors T1, T2, T3, a storage capacitor Cst, and a light emitting element LD.

Transistors T1, T2, T3 may include N-type transistors. In other embodiments, the transistors T1, T2, T3 may include P-type transistors. In other embodiments, the transistors T1, T2, T3 may include a combination of N-type transistors and P-type transistors. A P-type transistor refers to a transistor that increases an amount of current flowing through it when the voltage difference between the gate electrode and the source electrode increases in the negative direction. An N-type transistor is a transistor in which the amount of current flowing through it increases when the voltage difference between the gate and source electrodes increases in the positive direction. Transistors can be organized in various forms, including thin film transistors (TFTs), field effect transistors (FETs), and bipolar junction transistors (BJTs).

The first transistor T1 may have a gate electrode connected to a first node N1, a first electrode connected to a first power supply line ELVDD, and a second electrode connected to a second node N2. The first transistor T1 may be named as a drive transistor.

The second transistor T2 may have a gate electrode connected to the first scan line S1i, a first electrode connected to the data line Dj, and a second electrode connected to the first node N1. The second transistor T2 may be named as a scan transistor.

The third transistor T3 may have a gate electrode connected to the second scan line S2i, a first electrode connected to the second node N2, and a second electrode connected to the sensing line Ik. The third transistor T3 may be named as a sensing transistor.

The storage capacitor Cst may have a first electrode connected to the first node N1 and a second electrode connected to the second node N2.

The light emitting element LD may have an anode connected to the second node N2 and a cathode connected to the second power supply line ELVSS. The light emitting element LD may emit light of one of the first color, the second color, and the third color. The light emitting element LD may be a light emitting diode.

Generally, the voltage of the first power supply line ELVDD may be greater than the voltage of the second power supply line ELVSS. However, in special circumstances, for example, to prevent the light emitting element LD from emitting, the voltage of the second power supply line ELVSS may be set to be greater than the voltage of the first power supply line ELVDD.

The sensing channel 151 may include a first switch SW1, a second switch SW2, and a sensing capacitor Css.

The first electrode of the first switch SW1 may be connected to the third node N3. For example, the third node N3 may correspond to the sense line Ik. The second electrode of the first switch SW1 may receive an initialization voltage Vint. For example, the second electrode of the first switch SW1 may be connected to an initialization power source that supplies the initialization voltage Vint.

The first electrode of the second switch SW2 may be connected to the third node N3 and the second electrode of the second switch SW2 may be connected to the fourth node N4.

The sense capacitor Css may have a first electrode connected to the fourth node N4 and a second electrode connected to a reference power source (e.g., ground).

Although not shown, the sensing unit 15 may include analog-to-digital converters. For example, the sensing unit 15 may include analog-to-digital converters corresponding to a number of sensing channels. The analog-to-digital converters may convert the sensing voltage stored in the sensing capacitor Css to a digital value. The converted digital value may be provided to the timing controller 11 as sensing data. In other examples, the sensing unit 15 may include fewer analog-to-digital converters than the sensing channels and may convert the sensing signals stored in the sensing channels in a time divisional manner.

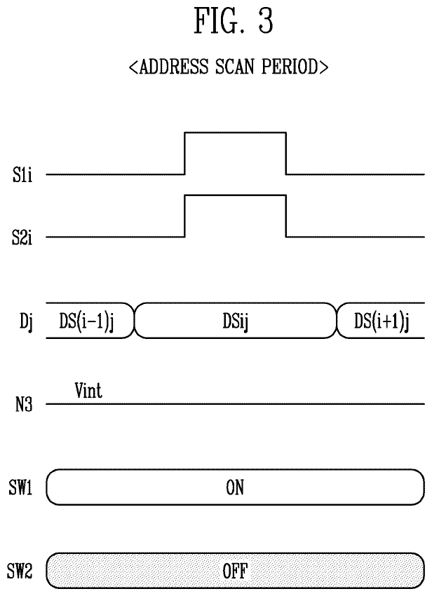

FIG. 3 is a drawing to illustrate an address scan period according to one embodiment of the present disclosure.

Referring to FIG. 3, during the address scan period, the sensing line Ik, i.e., the third node N3, may receive an initialization voltage Vint. During the address scan period, the first switch SW1 may be in the turn-on state and the second switch SW2 may be in the turn-off state.

During the address scan period, data voltages DS(i−1)j, DSij, DS(i+1)j may be sequentially applied to the data lines Dj in horizontal periods. In the corresponding horizontal period, a first scan signal of a turn-on level (e.g., logic high level) may be applied to the first scan line S1i. Additionally, in synchronization with the first scan line S1i, a second scan signal at the turn-on level may be applied to the second scan line S2i. In other embodiments, during the address scan period, the second scan line S2i may always have a second scan signal of the turn-on level applied.

For example, when scan signals of a turn-on level are applied to the first scan line S1i and the second scan line S2i, the second transistor T2 and the third transistor T3 may be turned on. Accordingly, the storage capacitor Cst of the pixel SPij is written with a voltage corresponding to the difference between the data voltage DSij and the initialization voltage Vint.

In the pixel SPij, a voltage difference between the gate electrode and the source electrode of the first transistor T1 determines an amount of drive current flowing in a drive path connecting the first power supply line ELVDD, the first transistor T1, the light emitting element LD, and the second power supply line ELVSS. Depending on the amount of the driving current, an emission luminance of the light-emitting element LD may be determined.

Subsequently, when a scan signal of a turn-off level (e.g., a logic low level) is applied to the first scan line S1i and the second scan line S2i, the second transistor T2 and the third transistor T3 may be in a turn-off state. Thus, regardless of the voltage change of the data line Dj, the voltage difference between the gate electrode and the source electrode of the first transistor T1 may be maintained by the storage capacitor Cst, and the light emitting luminance of the light emitting element LD may be maintained.

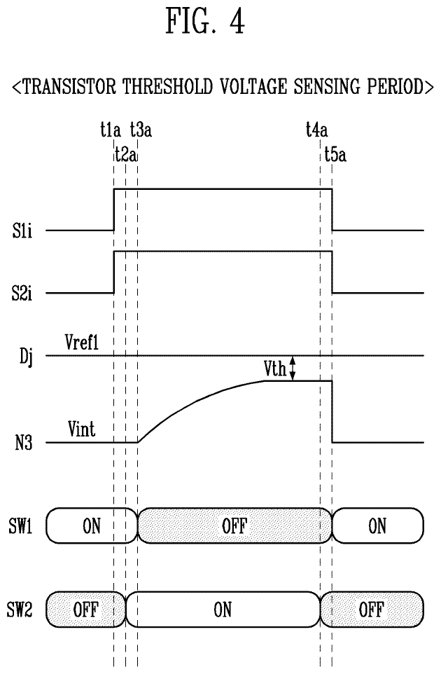

FIG. 4 is a drawing to illustrate a threshold voltage sensing period of a transistor according to one embodiment of the present disclosure.

Prior to time point t1a, the first switch SW1 may be in a turn-on state and the second switch SW2 may be in a turn-off state. Accordingly, an initialization voltage Vint may be applied to the third node N3. Further, the data driver 12 may supply a reference voltage Vref1 to the data line Dj.

At time point t1a, a first scan signal at the turn-on level may be supplied to the first scan line S1i and a second scan signal at the turn-on level may be supplied to the second scan line S2i. Accordingly, a reference voltage Vref1 may be applied to the first node N1 and an initialization voltage Vint may be applied to the second node N2. Accordingly, the first transistor T1 may be turned on according to the difference between the gate voltage and the source voltage.

At time point t2a, the second switch SW2 may be turned on. Accordingly, the first electrode of the sensing capacitor Css may be initialized to the initialization voltage Vint.

At time point t3a, the first switch SW1 may be turned off. Accordingly, the voltage of the second node N2 and the third node N3 may rise by supplying current from the first power supply line ELVDD. When the voltage of the second node N2 and the third node N3 rises to the voltage Vref1-Vth, the first transistor T1 is turned off, so that the voltage of the second node N2 and the third node N3 does not rise any further. Since the fourth node N4 is connected to the third node N3 through the second switch SW2, which is in the turn-on state, the sensing voltage Vref1-Vth is stored on the first electrode of the sensing capacitor Css.

At the time point t4a, the second switch SW2 is turned off, so that the sensing voltage Vref1-Vth of the first electrode of the sensing capacitor Css may be maintained. The sensing unit 15 may perform an analog-to-digital conversion of the sensing voltage Vref1-Vth, and thus may determine the threshold voltage Vth of the first transistor T1 of the pixel SPij.

At time point t5a, a first scan signal of the turn-off level may be supplied to the first scan line S1i and a second scan signal of the turn-off level may be supplied to the second scan line S2i. Further, the first switch SW1 may be turned on. Accordingly, an initialization voltage Vint may be applied to the third node N3.

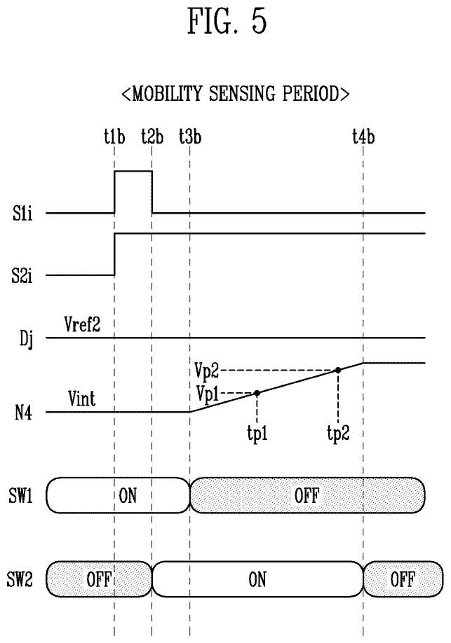

FIG. 5 is a diagram to illustrate a mobility sensing period according to one embodiment of the present disclosure.

At time t1b, a first scan signal of the turn-on level may be applied to the first scan line S1i and a second scan signal of the turn-on level may be applied to the second scan line S2i. The data line Dj has the reference voltage Vref2 applied to it, so that the reference voltage Vref2 may be applied to the first node N1. Further, since the first switch SW1 is in the turn-on state, an initialization voltage Vint may be applied to the second node N2 and the third node N3. Accordingly, the first transistor T1 may be turned on according to the difference between the gate voltage and the source voltage.

At time point t2b, the first node N1 may be in a floating state as the first scan signal at the turn-off level is applied to the first scan line S1i. Further, as the second switch SW2 is turned on, an initialization voltage Vint may be applied to the fourth node N4.

At time point t3b, the first switch SW1 may be turned off. Accordingly, the voltage of the second, third, and fourth nodes N2, N3, and N4 rises as current is supplied through the first transistor T1 from the first power supply line ELVDD. Because the first node N1 is in a floating state, the gate-source voltage difference of the first transistor T1 can be maintained.

At time point t4b, the second switch SW2 may be turned off. Accordingly, a sensing voltage is stored in the sensing capacitor Css. The sensing current of the first transistor T1 can be obtained as shown in the following Equation 1.

$$I = C * ( Vp 2 - Vp 1 ) / ( tp 2 - tp 1 ) \qquad [ Equation 1 ]$$

Where I is the sensing current of the first transistor T1, C is the capacitance of the sensing capacitor Css, Vp2 is the sensing voltage at time tp2, and Vp1 is the sensing voltage at time tp1.

Assuming that the voltage gradient of the fourth node N4 between time t3b and time t4b is linear, the sensing voltage at time t3b and the sensing voltage at time t4b can be known, so the sensing current of the first transistor T1 can be calculated. Further, the calculated sensing current can be used to calculate the mobility of the first transistor T1. For example, the larger the sensing current, the larger the mobility may be. For example, the magnitude of the mobility may be proportional to the magnitude of the sensing current.

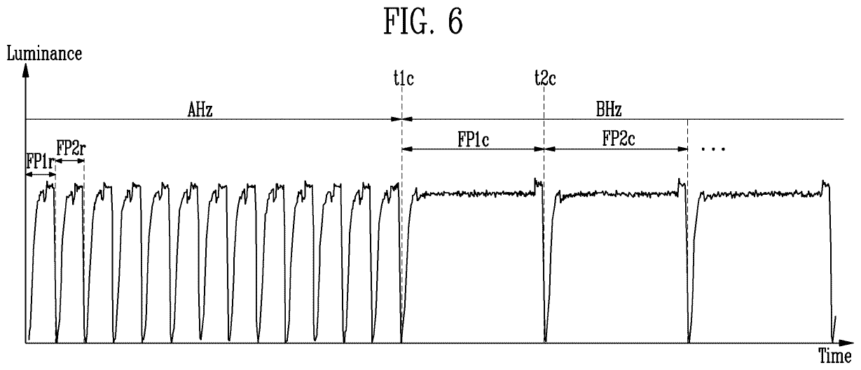

FIG. 6 is a diagram to illustrate the difference in luminance as frequency changes.

Referring now to FIG. 6, the luminance of the display device DD over time is exemplarily illustrated. For example, the display device DD may display an image at a first frequency AHz and start displaying an image at a second frequency BHz at a time point t1c. The second frequency BHz may be smaller than the first frequency AHz. Accordingly, the lengths of the respective frame periods FP1c, FP2c, . . . when the display device DD displays the image at the second frequency BHz may be longer than the lengths of the respective frame periods FP1r, FP2r, . . . when the display device DD displays the image at the first frequency AHz. Accordingly, even if when the display device displays image frames including the same grayscales, the average luminance when displaying at the second frequency BHz may be higher than the average luminance when displaying at the first frequency AHz. Accordingly, a user may recognize an undesirable change in luminance as the frequency changes.

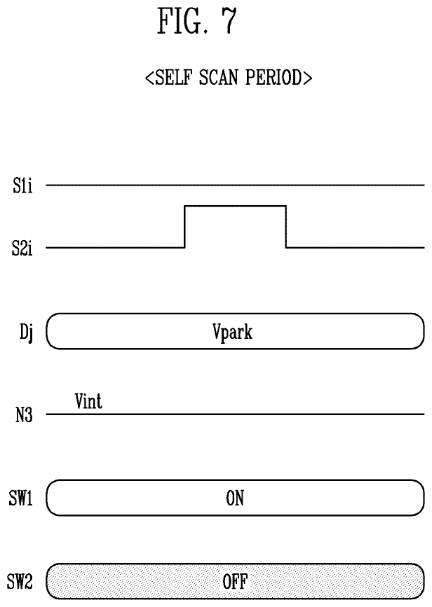

FIG. 7 is a drawing to illustrate a self-scan period according to one embodiment of the present disclosure.

Referring to FIG. 7, unlike the address scan period (see FIG. 3), during the self-scan period, a first scan signal of a turn-off level (e.g., a logic low level) may be maintained on the first scan line S1i in each horizontal period. A second scan signal of a turn-on level (e.g., a logic high level) may be applied to the second scan line S2i. The data line Dj may have a park voltage Vpark applied to it to reduce power consumption.

Referring to FIG. 2, during the self-scan period, the voltage of the second node N2 is initialized to the initialization voltage Vint. Thus, the light-emitting element LD may be turned off. The voltage difference between the two ends of the storage capacitor Cst is maintained, so that the light-emitting element LD may emit with the same luminance after the self-scan as before the self-scan.

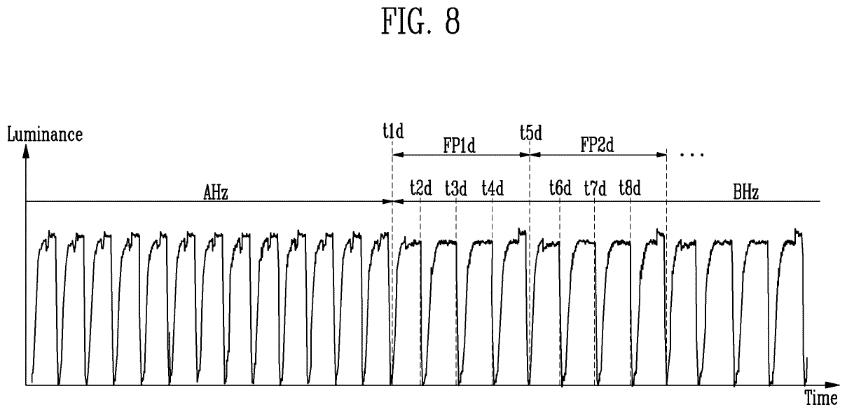

FIG. 8 is a drawing to illustrate the relaxation of luminance differences as frequency changes.

Referring to FIG. 8, the luminance of the display device DD over time is exemplarily illustrated. For example, the display device DD may display an image at a first frequency AHz and start displaying an image at a second frequency BHz at a time point t1d. For example, the lengths of the frame periods FP1d, FP2d, . . . in FIG. 8 may be the same as the lengths of the frame periods FP1c, FP2c, . . . in in FIG. 6.

The display device DD may, while displaying an image at the second frequency BHz, perform a self-scan at the third frequency. For example, during the frame period FP1d, an address scan period may start at a time point t1d, a first self-scan period may start at a time point t2d, a second self-scan period may start at a time point t3d, and a third self-scan period may start at a time point t4d. Similarly, during the frame period FP2d, the address scan period may begin at time point t5d, the first self-scan period may begin at time point t6d, the second self-scan period may begin at time point t7d, and the third self-scan period may begin at time point t8d. Since the light emitting elements LD are temporarily turned off during each self-scan period, the average luminance when the display device DD displays the image at the second frequency BHz may be lowered. Thus, when the display device DD displays an image frame including the same grayscales, the average luminance when displaying at the second frequency BHz and the average luminance when displaying at the first frequency AHz may be the same.

The third frequency may be determined such that the average luminance when the display device DD displays the image at the first frequency AHz is the same as the average luminance when the display device DD displays the image at the second frequency BHz. For example, the third frequency may be greater than the second frequency BHz.

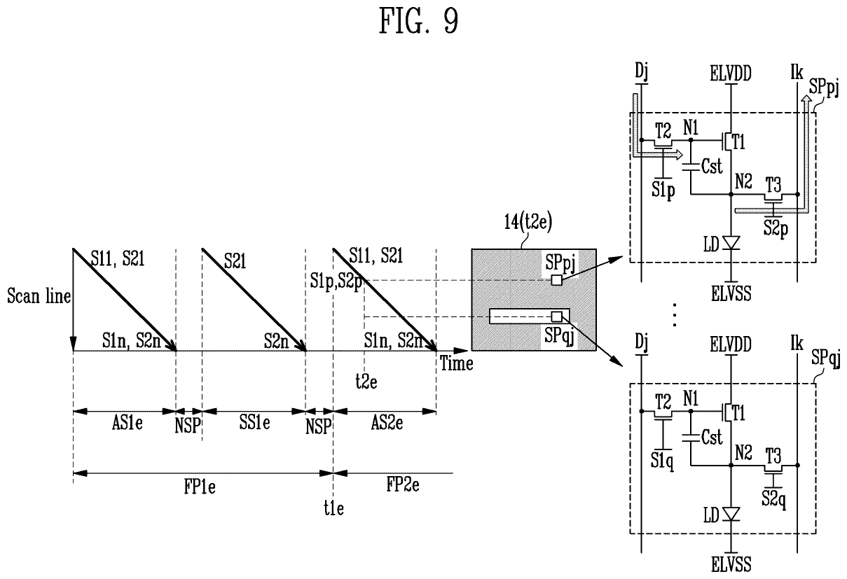

FIG. 9 is a diagram to illustrate the case where no copy pattern appears.

Referring to FIG. 9, a first frame period FP1e for displaying a first frame image and a second frame period FP2e for displaying a second frame image are exemplarily illustrated. The first frame period FP1e may sequentially include an address scan period AS1e, an idle period NSP, a self-scan period SS1e, and an idle period NSP. The second frame period FP2e may include the same periods as the first frame period FP1e. The second frame period FP2e may start from the address scan period AS2e.

The first frame period FP1e may end and the second frame period FP2e may begin at time t1e and the first frame period FP1e and the second frame period FP2e may not overlap.

During the address scan periods AS1e, AS2e, . . . , a first scan signal at the turn-on level may be applied to the first scan lines S11 to S1n and a second scan signal at the turn-on level may be applied to the second scan lines S21 to S2n. During the address scan periods AS1e, AS2e, . . . , data voltages corresponding to the grayscales of each frame period are written to the pixels.

During the self-scan periods SS1e, . . . , a first scan signal at the turn-off level may be maintained on the first scan lines S11 to S1n, and a second scan signal at the turn-on level may be applied to the second scan lines S21 to S2n.

At a time point t2e, an image displayed by the pixel unit 14 is exemplarily shown. For example, the pixel SPpj in the j-th column of the p-th row may receive and record a data voltage of the data line Dj in response to a first scan signal of a turn-on level applied to the first scan line S1p and a second scan signal of a turn-on level applied to the second scan line S2p. The second transistor T2 and the third transistor T3 of the pixel SPqj of the j-th column of the q-th row may be in a turn-off state, and may not affect the recording of the data voltage of the pixel SPpj. Thus, in the example of FIG. 9, the copy pattern may not occur. Where, “p” may be an integer greater than zero and “q” may be an integer greater than “p”.

Immediately after time point t2e, pixel SPpj will emit with a luminance corresponding to the second frame image and pixel SPqj will emit with a luminance corresponding to the first frame image.

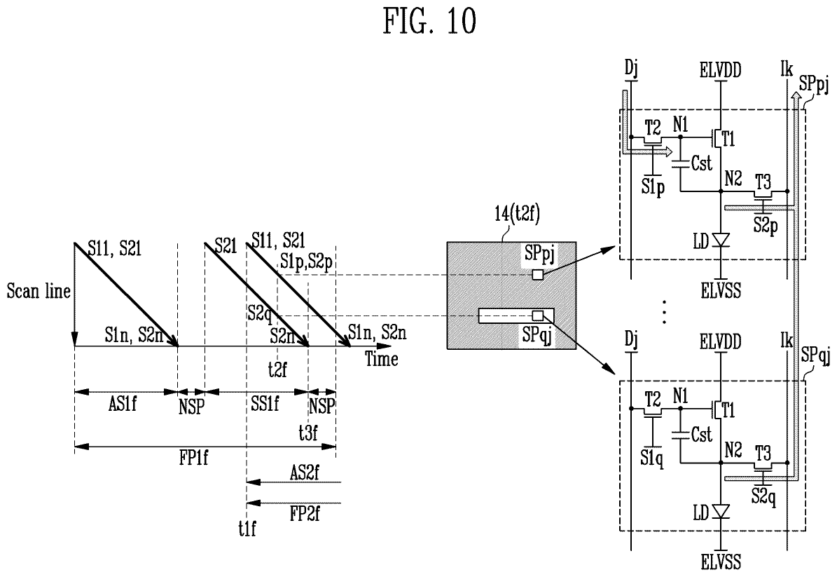

FIG. 10 is a diagram to illustrate when a copy pattern appears.

Referring to FIG. 10, a first frame period FP1f for displaying a first frame image and a second frame period FP2f for displaying a second frame image are illustrated in an example. The first frame period FP1f may sequentially include an address scan period AS1f, an idle period NSP, a self-scan period SS1f, and an idle period NSP. The second frame period FP2f may include the same periods as the first frame period FP1f The second frame period FP2f may starts from an address scan period AS2f.

The example of FIG. 10 differs from the example of FIG. 9 in that the second frame period FP2f begins at time t1f before the first frame period FP1f ends. Therefore, the first frame period FP1f and the second frame period FP2f may overlap each other. As described above in FIG. 8, the third frequency corresponding to a cycle period of the self-scan may be determined such that the average luminance when the display device DD displays an image at the first frequency AHz and the average luminance when the display device DD displays an image at the second frequency BHz are the same. Accordingly, the third frequency may not be an integer multiple of the second frequency BHz, and the first frame period FP1f and the second frame period FP2f may overlap each other, as shown in FIG. 10.

At a time point t2f, an image displayed by the pixel unit 14 is shown in an example. For example, the pixel SPpj in the j-th column of the p-th row may receive and record a data voltage of the data line Dj in response to a first scan signal of a turn-on level applied to the first scan line S1p and a second scan signal of a turn-on level applied to the second scan line S2p. The pixel SPqj in the j-th column of the q-th row may turn on the third transistor T3 in response to the second scanning signal of the turn-on level applied to the second scan line S2q. Accordingly, at the sensing line Ik, sink current from the pixel SPqj may additionally flow. Accordingly, a voltage higher than the initialization voltage Vint may be applied to the second node N2 of the pixel SPpj. Thus, the gate-source voltage of the first transistor T1 of the pixel SPpj becomes smaller than the target value. Immediately after the time point t2f, the pixel SPpj emits with a lower luminance than the target value. The decrease in luminance is influenced by the grayscale of the first frame period of the pixel SPqj. Therefore, in the example of FIG. 10, the pixel SPpj may display a copy pattern of the pixel SPqj. As the pixel SPqj displays a high luminance pattern, the sink current becomes larger, and thus the copy pattern may appear more prominent.

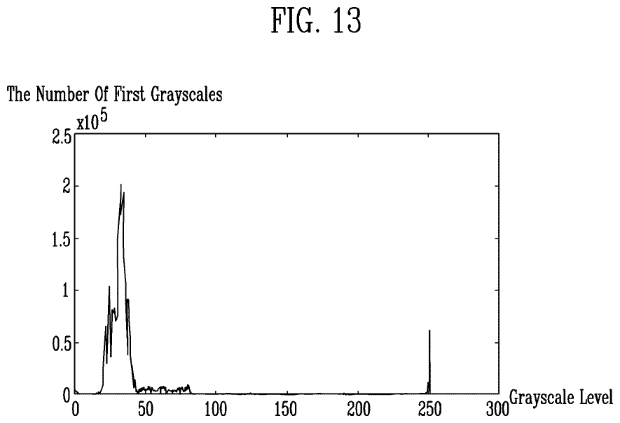

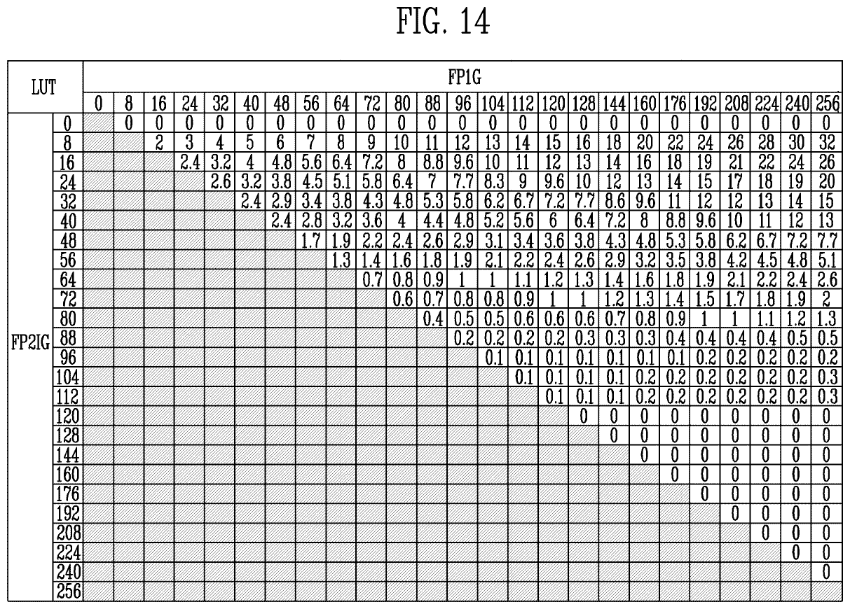

FIG. 11 is a drawing for illustrating a grayscale compensation unit according to one embodiment of the present disclosure. FIG. 12 is a drawing for illustrating a grayscale compensation unit according to another embodiment of the present disclosure. FIG. 13 is a drawing to illustrate a histogram analysis unit according to one embodiment of the present disclosure. FIG. 14 is a drawing for illustrating an output grayscale determination unit according to one embodiment of the present disclosure.

Referring to FIG. 11, the grayscale compensation unit 16a according to one embodiment of the present disclosure may include a high luminance pattern detection unit 161a, a compensation area determination unit 162a, a copy pattern prediction unit 163a, and an output grayscale determination unit 164a.

The grayscale compensation unit 16a may generate the compensation grayscales FP2OG by compensating the second grayscales FP2IG using the first grayscales FP1G of the first frame image and the second grayscales FP2IG of the second frame image. The pixels may display a second frame image based on the compensated grayscales FP2OG. The second frame image may correspond to the next frame of the first frame image.

The grayscale compensation unit 16a may detect a high luminance pattern in the first frame image and generate a compensation grayscales FP2OG if it is predicted that a copy pattern of the high luminance pattern in the first frame image will be displayed in the second frame image based on the second grayscales FP2IG.

The high luminance pattern detection unit 161a may provide position information HLPP of the first pixels which display the high luminance pattern during the first frame. For example, the high luminance pattern detection unit 161a may receive first grayscales FP1G of the first frame image as input and may determine that grayscales above a threshold value among the first grayscales FP1G are high luminance patterns. For example, the high luminance pattern detection unit 161a may judge the pixel SPqj of FIG. 10 as a first pixel displaying a high luminance pattern and may provide position information HLPP for the first pixel SPqj to the copy pattern prediction unit 163a.

The compensation area determination unit 162a may determine, based on the frequency information FQI, an overlap period t1f to t3f of the last self-scan period SS1f of the first frame period FP1f and the address scan period AS2f of the second frame period FP2f. For example, the frequency information FQI may include a frequency at which the display device DD displays the first frame image (e.g., a second frequency BHz) and a frequency at which the display device DD performs a self-scan (e.g., a third frequency). The third frequency may not be an integer multiple of the second frequency BHz and the first frame period FP1f and the second frame period FP2f may overlap with each other, as shown in FIG. 10.

In addition, the compensation area determination unit 162a may provide position information CTAP of the second pixels receiving data voltages of the second frame image during the overlap periods t1f through t3f.

The copy pattern prediction unit 163a may, based on the position information of the first pixels HLPP and the position information of the second pixels CTAP, provide the positions of the second pixels receiving the data voltages of the second frame image at the luminance initialization time points of the first pixels as copy pattern position information CPPA. Referring to FIG. 10, the copy pattern position information CPPA may include the position of the second pixel SPpj receiving the data voltage of the second frame image at the luminance initialization time point t2f of the first pixel SPqj.

The output gray scale determination unit 164a may generate compensation values based on the second grayscales FP2IG of the second pixels and the first grayscales FP1G of the first pixels corresponding to the copy pattern position information CPPA. Further, the output gray scale determination unit 164a may generate the compensation gray scales FP2OG by applying the compensation values to the second gray scales FP2IG.

For example, the output grayscale determination unit 164a may generate the compensation values by referring to a lookup table such as the lookup table shown in FIG. 14. The lookup table may be stored in an internal memory of the grayscale compensation unit 16a, or may be stored in a memory of the display device DD. Referring to FIG. 14, compensation values corresponding to the first grayscales of the first pixels FP1G and the second grayscales of the second pixels FP2IG are stored in the lookup table. For example, the output gray scale determination unit 164a may generate the compensation gray scale FP2OG by adding the corresponding compensation value to the second gray scale FP2IG. If the compensation value is a decimal point, the display device DD may dither the second pixel and its neighboring pixels to express the luminance of the grayscale.

Referring to FIG. 12, the grayscale compensation unit 16b according to one embodiment of the present disclosure may include a high luminance pattern detection unit 161b, a compensation area determination unit 162b, a copy pattern prediction unit 163b, and an output grayscale determination unit 164b. In addition, the grayscale compensation unit 16b may further include a histogram analysis unit 165b and a grayscale difference comparison unit 166b. In the following, the grayscale compensation units 16a, 16b will be further described only in terms of their differences, excluding overlapping descriptions.

The high luminance pattern detection unit 161b may provide first position information HLPP1 of the first pixels corresponding to the high luminance pattern and a histogram HIST of the first grayscales FP1G. Referring to FIG. 13, a histogram HIST of the first grayscales FP1G is shown in an example. For example, the histogram HIST may be information of the number of first grayscales FP1G belonging to each grayscale level (e.g., 0 to 255 when represented by 8 bits). For example, a grayscale level of 0 may be the darkest grayscale level, and a grayscale level of 255 may be the brightest grayscale level.

The histogram analysis unit 165b may provide a second position information HLPP2 of the first pixels corresponding to the high luminance pattern if the grayscale difference between the high luminance pattern and the low luminance pattern is greater than a first threshold value based on the histogram HIST. For example, referring to FIG. 13, it can be seen that the high luminance pattern is located near a 250 grayscale level, and the low luminance pattern is located below a 50 grayscale level. For example, the histogram analysis unit 165b may calculate a difference value between the average grayscale level of the high luminance pattern and the average grayscale level of the low luminance pattern. If the difference value is greater than a first threshold value, the histogram analysis unit 165b may provide a second position information HLPP2 of the first pixels corresponding to the high luminance pattern. According to the present embodiment, by operating the grayscale compensation unit 16b only for high luminance patterns that generate relatively large sink currents, unnecessary compensation algorithms may be prevented from being performed.

The copy pattern prediction unit 163b may operate to generate the first copy pattern position information CPPA1 based on the second position information HLPP2 provided by the histogram analysis unit 165b.

The grayscale difference comparison unit 166b may provide the second copy pattern position information CPPA2 corresponding to the first copy pattern position information CPPA1 if the difference between the second grayscales of the second pixels FP2IG and the first grayscales of the first pixels FP1G corresponding to the first copy pattern position information CPPA1 is greater than a second threshold value. Referring to FIG. 14, it can be seen that the larger the first grayscales FP1G and the smaller the second grayscales FP2IG, the greater the compensation required. The output grayscale determination unit 164b may operate based on the second copy pattern position information CPPA2 provided by the grayscale difference comparison unit 166b. According to the present embodiment, by operating the grayscale compensation unit 16b only for grayscale differences that necessarily require compensation, unnecessary compensation algorithms may be prevented from being performed.

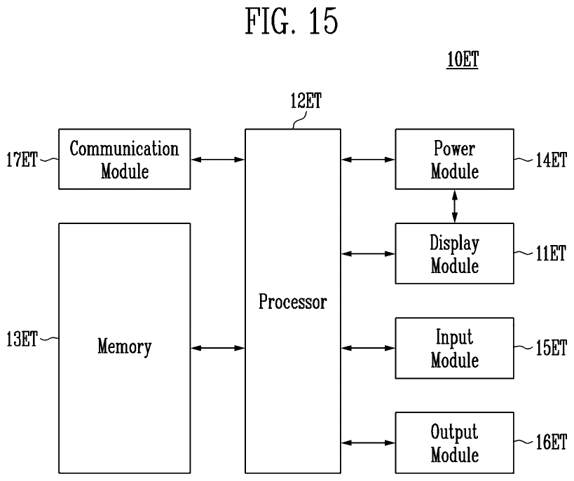

FIG. 15 is a block diagram of an electronic device according to one embodiment. Referring to FIG. 15, the electronic device 10ET according to one embodiment may include a display module 11ET, a processor 12ET, a memory 13ET, and a power module 14ET. The display module 11ET may also be represented by a display device.

The processor 12ET may include at least one of a central processing unit (CPU), an application processor (AP), a graphic processing unit (GPU), a communication processor (CP), an image signal processor (ISP), and a controller. In one embodiment, the processor 12ET may include two or more processors which are distinguished from a functional or structural perspective. For example, the processor 12ET may include a main processor in the form of a first drive chip that includes a central processing unit, and a second processor in the form of a second drive chip that includes a controller that receives image signals from the main processor and processes the image signals to meet interface specifications of the display module 11ET. The processor 12ET may provide an image signal (e.g., image data). The display module 11ET may display an image based on grayscales of the image signal.

The memory 13ET may include at least one of a non-volatile memory and a volatile memory. The memory 13ET may store data information necessary for operation of the processor 12ET or the display module 11ET. When the processor 12ET executes an application stored in the memory 13ET, image data signals and/or input control signals may be delivered to the display module 11ET, and the display module 11ET may process the received signals to output image information via the display screen.

The power module 14ET can include a power supply module, such as a power adapter or battery unit, and a power conversion module that converts the power supplied by the power supply module to generate the power required for operation of the electronic device 10ET. The power conversion by the power conversion module may include, but is not limited to, DC-DC conversion, AC-DC conversion, and DC-AC conversion.

The electronic device 10ET may further include an input module 15ET, a non-image output module 16ET, and/or a communication module 17ET.

The input module 15ET may provide input information to the processor 12ET and/or the display module 11ET. The input module 15ET may include physical buttons, a keyboard, a microphone, as well as various sensor modules. Examples of sensor modules may include touch sensors, pressure sensors, distance sensors, position sensors, digitizers, motion recognition sensors, camera sensors, light sensors, photoelectric sensors, temperature sensors, as well as biosensors such as blood pressure sensors, blood glucose sensors, electrocardiogram sensors, heart rate sensors, and the like.

The non-image output module 16ET may serve to receive information other than images received from the processor 12ET and provide it to a user. Examples of the non-image output module 16ET include an acoustic module, a haptic module, a light emitting module, and the like, and may include other functional modules unique to the electronic device (e.g., a cooling module in a refrigerator, etc.).

The communication module 17ET is a module responsible for sending and receiving information between the electronic device 10ET and an external device, and may include a receiving part and a transmitting part. The communication module 17ET may include various wireless communication modules such as a mobile communication module, a Wi-Fi module, a Bluetooth module, or various wired communication modules.

At least one of each of the above-described configurations of the electronic device 10ET may be included within the display device according to the above-described embodiments. Furthermore, some of the individual modules that are functionally included within one module may be included within the display device and others may be provided separately from the display device. For example, the display device may include a display module 11ET, while the processor 12ET, memory 13ET, and power module 14ET may be provided in the form of other devices within the electronic device 10ET other than the display device. As another example, the power module 14ET may be provided within the display device and power the processor 12ET and memory 13ET provided within the electronic device 10ET that is not the display device without limiting the above example.

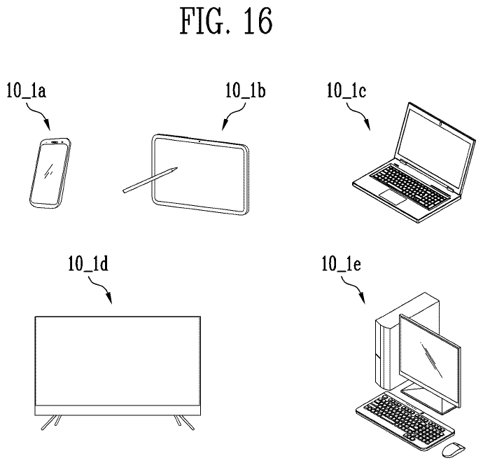

FIG. 16 to FIG. 18 are schematic diagrams of electronic devices according to various embodiments. FIG. 16 to FIG. 18 illustrate examples of various electronic devices with indicating devices according to various embodiments.

FIG. 16 illustrates a smartphone 10_1a, a tablet PC 10_1b, a laptop 10_1c, a TV 10_1d, and a desk monitor 10_1e as examples of electronic devices.

In addition to the display module 11ET, the smartphone 10_1a may include an input module, such as a touch sensor, and a communication module. The smartphone 10_1a may process information received via the communication module or other input module and display the information via the display module of the display device.

Similar to the smartphone 10_1a, the tablet PC 10_1b, laptop 10_1c, TV 10_1d, and desk monitor 10_1e also include a display module and an input module, and in some cases may further include a communication module.

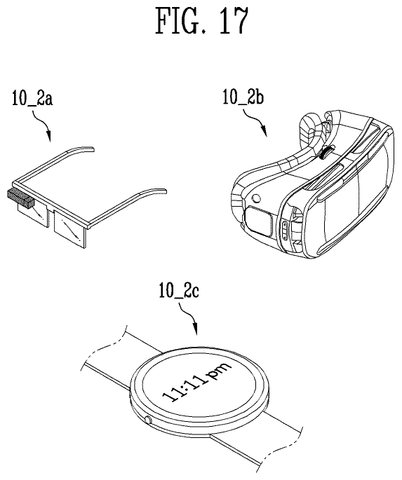

FIG. 17 illustrates an electronic device including a display module applied to a wearable electronic device. The wearable electronic device may be a smart glasses 10_2a, a head-mounted display 10_2b, a smart watch 10_2c, or the like.

The smart glasses 10_2a and the head-mounted display 10_2b may include a display module that projects a display image and a reflector that reflects the projected display image and presents it to the user's eyes, thereby providing the user with a view of virtual reality or augmented reality.

The smartwatch 10_2C includes a biometric sensor as an input device and may provide biometric information recognized through the biometric sensor to a user via a display module.

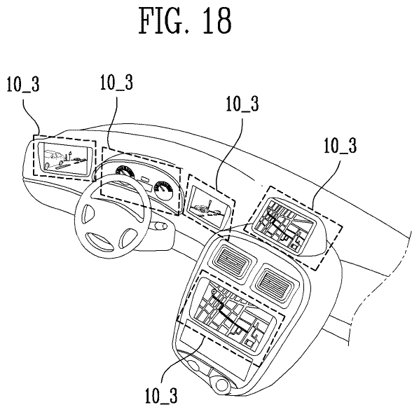

FIG. 18 illustrates an example of an electronic device including a display module applied to a vehicle. For example, the electronic device 10_3 may be applied to an instrument panel, center fascia, or the like of a vehicle, or to a center information display (CID) placed on the dashboard of a vehicle, or to a room mirror display that replaces a side mirror.

Although not shown, electronic devices with display modules according to embodiments may include not only screen-display oriented devices such as advertisement boards, billboards, and gaming machines, but also various home appliances that display information via display modules, such as refrigerators, washers, dryers, air conditioners, robotic vacuum cleaners, and the like. Furthermore, if the display module has a function of transmitting light, it may be applied to an electronic device such as a smart window or a transparent display device that displays a background and a display image together. The types of electronic devices according to the embodiments are not limited by the above examples, and it is possible to apply various other electronic devices not shown.

Display devices and electronic devices according to the present disclosure can effectively eliminate or mitigate copy patterns.

The foregoing referenced drawings and detailed description of the disclosure are merely exemplary and are intended to illustrate the disclosure and are not intended to limit the meaning or to limit the scope of the disclosure as claimed in the appended patent claims. Accordingly, one having ordinary knowledge in the art will understand that various modifications and equally obvious other embodiments are possible from them. Accordingly, the true scope of technical protection of the disclosure should be determined by the technical ideas of the appended patent claims.

What is claimed is:

1. A display device comprising:
a grayscale compensation unit generating compensation grayscales of a second frame by compensating second grayscales of the second frame using first grayscales of a first frame image and the second grayscales of a second frame image; and
pixels displaying the second frame image based on the compensation grayscales,
wherein the grayscale compensation unit detects a high luminance pattern in the first frame image and generates the compensation grayscales if, based on the second grayscales, a copy pattern of the high luminance pattern is predicted to be displayed in the second frame image.

2. The display device of claim 1, wherein the grayscale compensation unit comprises:
a high luminance pattern detection unit providing position information of first pixels displaying the high luminance pattern.

3. The display device of claim 2, wherein the grayscale compensation unit further comprises:
a compensation area determination unit determining, based on frequency information, an overlap period of a last self-scan period of a first frame period and an address scan period of a second frame period, and providing position information of second pixels receiving data voltages of the second frame image during the overlap period.

4. The display device of claim 3, wherein the grayscale compensation unit further comprises:
a copy pattern prediction unit providing, based on position information of the first pixels and position information of the second pixels, positions of the second pixels receiving data voltages of the second frame image at luminance initialization times of the first pixels as copy pattern position information.

5. The display device of claim 4, wherein the grayscale compensation unit further comprises:
an output grayscale determination unit generating compensation values based on the second grayscales of the second pixels and the first grayscales of the first pixels corresponding to the copy pattern position information, and applying the compensation values to the second grayscales to generate the compensation grayscales.

6. The display device of claim 1, wherein the grayscale compensation unit comprises:
a high luminance pattern detection unit providing a histogram of the first grayscales and first position information of first pixels corresponding to the high luminance pattern; and
a histogram analysis unit providing second position information of the first pixels corresponding to the high luminance pattern if, based on the histogram, a grayscale difference between the high luminance pattern and low luminance pattern is greater than a first threshold value.

7. The display device of claim 6, wherein the grayscale compensation unit further comprises:
a compensation area determination unit determining, based on frequency information, an overlap period of a last self-scan period of a first frame period and an address scan period of a second frame period, and providing position information of second pixels receiving data voltages of the second frame image during the overlap period.

8. The display device of claim 7, wherein the grayscale compensation unit further comprises:
a copy pattern prediction unit providing, based on position information of the first pixels and position information of the second pixels, positions of the second pixels receiving data voltages of the second frame image at luminance initialization times of the first pixels, as first copy pattern position information.

9. The display device of claim 8, wherein the grayscale compensation unit further comprises:
a grayscale difference comparison unit providing a second copy pattern position information corresponding to the first copy pattern position information if a difference between the second grayscales of the second pixels and the first grayscales of the first pixels corresponding to the first copy pattern position information is greater than a second threshold value.

10. The display device of claim 9, wherein the grayscale compensation unit further comprises:
an output grayscale determination unit generating compensation values based on the second grayscales of the second pixels and the first grayscales of the first pixels corresponding to the second copy pattern position information, and applying the compensation values to the second grayscales to generate the compensation grayscales.

11. An electronic device comprising:
a processor providing an image signal; and
a display device displaying an image based on the image signal,
wherein the display device comprises:
a grayscale compensation unit generating compensation grayscales of a second frame by compensating second grayscales of the second frame using first grayscales of a first frame image and the second grayscales of a second frame image; and
pixels displaying the second frame image based on the compensation grayscales, and
wherein the grayscale compensation unit detects a high luminance pattern in the first frame image, and generates the compensation grayscales if, based on the second grayscales, a copy pattern of the high luminance pattern is predicted to be displayed in the second frame image.

12. The electronic device of claim 11, wherein the grayscale compensation unit comprises:
a high luminance pattern detection unit providing position information of first pixels displaying the high luminance pattern.

13. The electronic device of claim 12, wherein the grayscale compensation unit further comprises:
a compensation area determination unit determining, based on frequency information, an overlap period of a last self-scan period of a first frame period and an address scan period of a second frame period, and providing position information of second pixels receiving data voltages of the second frame image during the overlap period.

14. The electronic device of claim 13, wherein the grayscale compensation unit further comprises:
a copy pattern prediction unit providing, based on position information of the first pixels and position information of the second pixels, positions of the second pixels receiving data voltages of the second frame image at luminance initialization times of the first pixels as copy pattern position information.

15. The electronic device of claim 14, wherein the grayscale compensation unit further comprises:
an output grayscale determination unit generating compensation values based on the second grayscales of the second pixels and the first grayscales of the first pixels corresponding to the copy pattern position information, and applying the compensation values to the second grayscales to generate the compensation grayscales.

16. The electronic device of claim 11, wherein the grayscale compensation unit comprises:
a high luminance pattern detection unit providing a histogram of the first grayscales and first position information of first pixels corresponding to the high luminance pattern; and
a histogram analysis unit providing second position information of the first pixels corresponding to the high luminance pattern if, based on the histogram, a grayscale difference between the high luminance pattern and low luminance pattern is greater than a first threshold value.

17. The electronic device of claim 16, wherein the grayscale compensation unit further comprises:
a compensation area determination unit detecting, based on frequency information, an overlap period of a last self-scan period of a first frame period and an address scan period of a second frame period, and providing position information of second pixels receiving data voltages of the second frame image during the overlap period.

18. The electronic device of claim 17, wherein the grayscale compensation unit further comprises:
a copy pattern prediction unit providing, based on position information of the first pixels and position information of the second pixels, positions of the second pixels receiving data voltages of the second frame image at luminance initialization times of the first pixels as first copy pattern position information.

19. The electronic device of claim 18, wherein the grayscale compensation unit further comprises:
a grayscale difference comparison unit providing a second copy pattern position information corresponding to the first copy pattern position information if a difference between the second grayscales of the second pixels and the first grayscales of the first pixels corresponding to the first copy pattern position information is greater than a second threshold value.

20. The electronic device of claim 19, wherein the grayscale compensation unit further comprises:
an output grayscale determination unit generating compensation values based on the second grayscales of the second pixels and the first grayscales of the first pixels corresponding to the second copy pattern position information, and applying the compensation values to the second grayscales to generate the compensation grayscales.
